(19) United States
(12) Patent Application Publication
(10) Pub. No.: US 2024/0178408 A1
(43) Pub. Date: May 30, 2024

(54) SOLID OXIDE CELL AND COMPOSITION FOR AIR ELECTRODE THEREOF

(71) Applicant: SAMSUNG ELECTRO-MECHANICS CO., LTD., Suwon-si (KR)

(72) Inventors: Jung Deok PARK, Suwon-si (KR); Hong Ryul LEE, Suwon-si (KR); Jae Seok YI, Suwon-si (KR)

(73) Assignee: SAMSUNG ELECTRO-MECHANICS CO., LTD., Suwon-si (KR)

(21) Appl. No.: 18/220,993

(22) Filed: Jul. 12, 2023

(30) Foreign Application Priority Data
Nov. 30, 2022 (KR) 10-2022-0164768
Jan. 20, 2023 (KR) 10-2023-0009044

(51) Int. Cl. H01M 4/90

(52) U.S. Cl. CPC H01M 4/9033; H01M 2008/1293

(57) ABSTRACT

A solid oxide cell includes a fuel electrode, an air electrode, and an electrolyte disposed between the fuel electrode and the air electrode, wherein the air electrode includes an ion-electron conductor and an ion conductor, and the ion-electron conductor comprises a compound represented by ABO₃, where A includes La, and B includes Sc and at least one of Fe, Mn or Co.

### CROSS-REFERENCE TO RELATED APPLICATION (S)

This application claims benefit of priority to Korean Patent Application No. 10-2022-0164768 and 10-2023-0009044 filed on Nov. 30, 2022, and Jan. 20, 2023, respectively, in the Korean Intellectual Property Office, the disclosures of which are incorporated herein by reference in its entirety.

### TECHNICAL FIELD

The present disclosure relates to a solid oxide cell and a composition for an air electrode thereof.

A solid oxide fuel cell (SOFC) and a solid oxide electrolysis cell (SOEC) include a cell comprised of a solid electrolyte having an air electrode, a fuel electrode, and oxygen ion conductivity, and the cell may be referred to as a solid oxide cell. A solid oxide cell produces electrical energy by electrochemical reactions, or produces hydrogen by electrolyzing water by reverse reactions of the solid oxide fuel cell. The solid oxide cell has low overvoltage based on low activation polarization and has high efficiency due to low irreversible loss, as compared to other types of fuel cells or water electrolysis cells, such as a phosphoric acid fuel cell (PAFC), an alkaline fuel cell (AFC), a polymer electrolyte fuel cell (PEMFC), a direct methanol fuel cell (DMFC). Furthermore, because the solid oxide cell may not only be used with a hydrogen fuel but may also be used with carbon or hydrocarbon fuel, it can have a wide range of fuel choices, and because the solid oxide cell has a high reaction rate in an electrode, it does not require an expensive precious metal as an electrode catalyst.

When actually implementing a device such as a fuel cell and a water electrolysis cell, a stack structure in which interconnects and solid oxide cells are stacked on each other has been widely used. In a process of assembling the stack structure of a solid oxide cell or operating the device, pressure may be applied to the solid oxide cell, which may cause cracks or damage to the solid oxide cell.

An electrode layer of the solid oxide cell may include a conductive material of ions and electrons, and it is required to increase overall conductivity of the electrode layer in order to improve the performance of the solid oxide cell.

### SUMMARY

An aspect of the present disclosure is to realize a solid oxide cell having improved performance by including an electrode layer having high ion conductivity therein. Furthermore, another aspect of the present disclosure is to provide a composition for an air electrode of a high-efficiency solid oxide cell functioning as an ion-electron conductor.

In order to solve the above-described issues, according to an aspect of the present disclosure, a novel structure of a solid oxide cell is proposed, and the solid oxide cell includes a fuel electrode, an air electrode, and an electrolyte disposed between the fuel electrode and the air electrode, wherein the air electrode includes an ion-electron conductor and an ion conductor, and the ion-electron conductor comprises a compound represented by ABO₃, where A includes La, and B includes Sr and at least one of Fe, Mn or Co.

According to some example embodiments of the present disclosure, A further includes at least one of Sr or Ca.

According to some example embodiments of the present disclosure, a content of at least one of Sr or Ca is 40 mol or less relative to the total content of 100 mol of A.

According to some example embodiments of the present disclosure, a content of Sc is less than 10 mol relative to the total content of 100 mol of B.

According to some example embodiments of the present disclosure, the content of Sc is 5 mol or more relative to the total content of 100 mol of B.

According to some example embodiments of the present disclosure, the ion conductor includes at least one of scandia stabilized zirconia (SSZ), yttria stabilized zirconia (YSZ), scandia ceria stabilized zirconia (SCSZ), scandia ceria yttria stabilized zirconia (SCYSZ), or scandia ceria ytterbia stabilized zirconia (SCYbSZ).

According to some example embodiments of the present disclosure, a weight ratio of the ion-electron conductor to the ion conductor in the air electrode is 30:70 to 70:30.

Meanwhile, according to another aspect of the present disclosure, a solid oxide cell includes: a fuel electrode, an air electrode, and an electrolyte disposed between the fuel electrode and the air electrode, wherein the air electrode includes an ion-electron conductor, the ion-electron conductor comprises a compound represented by ABO₃, where A includes La, the B includes Sc and at least one of Fe, Mn or Co, and a content of Sc is less than 10 mol relative to the total content of 100 mol of B.

According to some example embodiments of the present disclosure, the content of Sc is 5 mol or more relative to the total content of 100 mol of B.

According to another aspect of the present disclosure, provided is a composition for an air electrode of a solid oxide cell, wherein the composition is represented by ABO₃, where A includes La, B includes Sc and at least one of Fe, Mn or Co, and a content of Sc is less than 10 mol relative to the total content of 100 mol of B.

According to some example embodiments of the present disclosure, the content of Sc is 5 mol or more relative to the total content of 100 mol of B.

When a solid oxide cell is implemented using a composition for an air electrode of the solid oxide cell according to some example embodiments of the present disclosure, ion conductivity of the air electrode may be improved. When such a solid oxide cell is used as a fuel cell or a water electrolysis cell, performance thereof may be improved.

### BRIEF DESCRIPTION OF DRAWINGS

The above and other aspects, features, and advantages of the present disclosure will be more clearly understood from the detailed following description, taken in conjunction with the accompanying drawings, in which:

FIG. 1 is a cross-sectional view schematically illustrating a solid oxide cell according to some example embodiments of the present disclosure;

FIG. 2 is a cross-sectional view schematically illustrating a solid oxide cell according to another example embodiments of the present disclosure;

FIG. 3 is an enlarged view of a region (i.e., region R1) of a fuel electrode as illustrated in FIG. 1;

FIG. 4 is an enlarged view of a region (i.e., region R2) of an air electrode as illustrated in FIG. 1;

FIG. 5 is a graph illustrating a result of measuring a change in electrical conductivity according to a temperature in an air electrode obtained from compositions having different addition amounts of Sc;

FIG. 6 is a graph illustrating measurement of polarization resistance to an oxygen reduction reaction in an air electrode obtained from compositions having different addition amounts of Sc;

FIG. 7 is a view illustrating a result of H₂-TPR (Temperature Programmed Reduction) analysis;

FIG. 8 is a view illustrating a relationship between current density and voltage in a solid oxide cell including the air electrode obtained from the compositions having different addition amounts of Sc, and power density according thereto; and

FIG. 9 is a view illustrating a relationship between current density and voltage in an air electrode formed by mixing a composite obtained by mixing LSFSc05 (Sc: 5 mol %) and an ion conductor (YSZ), and power density according thereto.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. In the drawings, the shapes and dimensions of elements may be exaggerated for clarity, and the same reference numerals will be used throughout to designate the same or like elements.

In order to clearly explain the present disclosure in the drawings, the contents unrelated to the description are omitted, thicknesses of each component are enlarged to clearly express multiple layers and regions, and components with the same function within the same range of ideas are described using the same reference numerals. Throughout the specification, when a certain portion “includes” or “comprises” a certain component, this indicates that other components are not excluded and may be further included unless otherwise noted.

The phrase “at least one of” means any combination of one or more of those things, unless expressly specified otherwise. For example, “at least one of X, Y or Z,” unless specifically stated otherwise, may be either only X, only Y, only Z, or any combinations thereof (e.g., X, Y and/or Z).

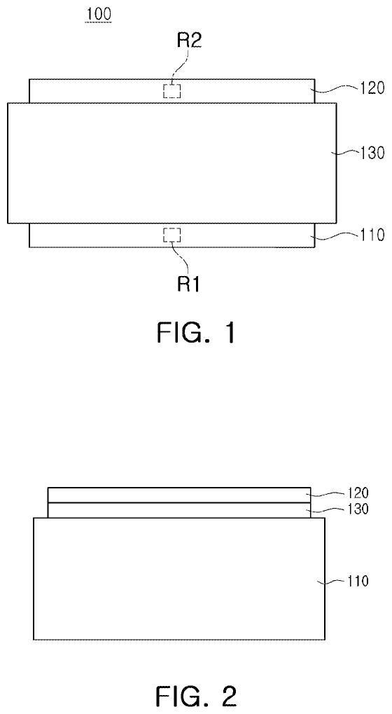

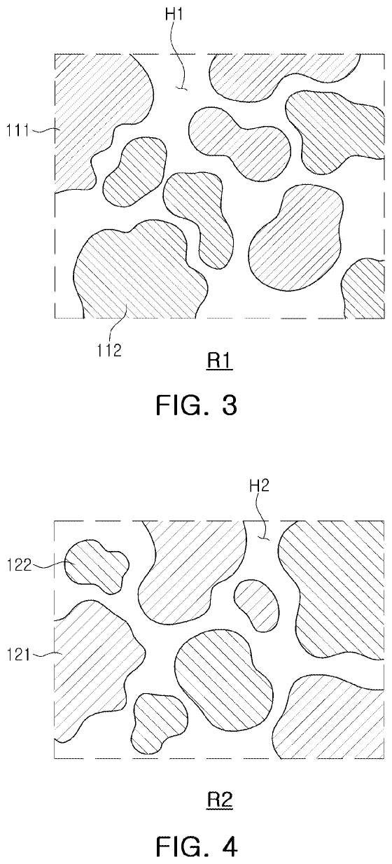

FIG. 1 is a cross-sectional view schematically illustrating a solid oxide cell according to some example embodiments of the present disclosure. FIG. 2 is a cross-sectional view schematically illustrating a solid oxide cell according to another example embodiments of the present disclosure. FIG. 3 is an enlarged view of a region (i.e., region R1) of a fuel electrode, and FIG. 4 is an enlarged view of a region (i.e., region R2) of an air electrode.

Referring to FIGS. 1 to 4, a solid oxide cell 100 according to some example embodiments of the present disclosure includes a fuel electrode 110, an air electrode 120, and an electrolyte 130 disposed therebetween, as main components. Here, the air electrode 120 includes an ion-electron conductor 121 and an ion conductor 122. Furthermore, the ion-electron conductor 121 comprises a compound represented by ABO₃, where A includes La, and B includes Sc and at least one of Fe, Mn or Co. In the example embodiments, as the air electrode 120 includes an ion-electron conductor 121 having high ion conductivity, reactivity in the air electrode 120 may be improved, thus improving the performance of the solid oxide cell 100. Hereinafter, the components of the solid oxide cell 100 are specifically described, and a case in which the solid oxide cell 100 is used as a fuel cell is mainly described. However, the solid oxide cell 100 may also be used as a water electrolysis cell, and in this case, a reaction opposite to the case of fuel cell will occur in the fuel electrode 110 and air electrode 120 of the solid oxide cell 120.

The fuel electrode 110 and the air electrode 120 correspond to an electrode layer in which a major reaction occurs in the solid oxide cell 100. Specifically, when the solid oxide cell 100 is the fuel cell, for example, water production by oxidation of hydrogen or an oxidation reaction of carbon compounds may occur in the fuel electrode 110, and an oxygen ion generation reaction due to oxygen decomposition may occur in the air electrode 120. When the solid oxide cell 100 is the water electrolytic cell, a reaction opposite thereto may occur, for example, a hydrogen gas may be generated according to a reduction reaction of water in the fuel electrode 110, and oxygen may be generated in the air electrode 120. Furthermore, as another example, when the solid oxide cell 100 is the fuel cell, a hydrogen decomposition (hydrogen ion generation) reaction occurs in the fuel electrode 110, and oxygen and hydrogen ions may be combined to generate water in the air electrode 120, and when the solid oxide cell 100 is the water electrolysis cell, a water decomposition (hydrogen and oxygen ion generation) reaction may occur in the fuel electrode 110, and oxygen may be generated in the air electrode 120.

Meanwhile, in the case of the solid oxide cell 100 of FIG. 1, the fuel electrode 110 and the air electrode 120 may correspond to a so-called electrolyte 130-supported solid oxide cell 100 supported by the electrolyte 130, and in this case, a width of the electrolyte 130 may be the widest and/or thickest among the fuel electrode 110, the air electrode 120, and the electrolyte 130. The electrolyte 130-supported solid oxide cell 100 may have excellent reliability, but the electrolyte 130 may be formed relatively thick to perform a support function. However, in addition to a support type of the electrolyte 130, other structures may be adopted. For example, as illustrated in an example embodiment of FIG. 2, the solid oxide cell 100 may be implemented as a support type of the fuel electrode 110, and in this case, the fuel electrode 110 may be the widest and/or thickest among the fuel electrode 110, the air electrode 120, and the electrolyte.

As illustrated in FIG. 3, the fuel electrode 110 may include an electron conductor 111 and an ion conductor 112, which may be a sintered body of particles. The electron conductor 111 may perform an electrical conduction function and a catalyst function, and may include, for example, a Ni-based material, a lanthanum chromite-based material (La₁₋ₓSrₓCrO₃, where 0≤x<1). Furthermore, the electron conductor 111 may include an yttria stabilized zirconia-based (YSZ) material, a ceria-based (CeO₂) material, a bismuth oxide-based (Bi₂O₃) material, and/or a lanthanum gallate-based (LaGaO₃) material. Furthermore, the fuel electrode 110 may be a porous body including pores H1, and gases, fluids, and the like, may enter and exit through the pores H1.

The electrolyte 130 may be disposed between the fuel electrode 110 and the air electrode 120, and ions may move to the fuel electrode 110 or the air electrode 120. As an example of the material constituting the electrolyte 130, a material constituting ion conductors 112 and 122 of the fuel electrode 110 and the air electrode 120, respectively, may be used. As a representative example, the electrolyte 130 include stabilized zirconia. Specifically, the may electrolyte 130 may include scandia stabilized zirconia (SSZ), yttria stabilized zirconia (YSZ), scandia ceria stabilized zirconia (SCSZ), scandia ceria yttria stabilized zirconia (SCYSZ), and/or scandia ceria ytterbia stabilized zirconia (SCYbSZ).

As illustrated in FIG. 4, the air electrode 120 may include the ion-electron conductor 121 and the ion conductor 122, which may be a sintered body of particles. The air electrode 120 may be a porous body including pores H2, and gas, fluid, and the like, may enter and exit through the pores H2. As described above, the ion-electron conductor 121 may include a compound represented by ABO₃, where A may include La, and B may be obtained from a composition for an air electrode including Sc and at least one of Fe, Mn or Co, and Sc may increase the ion conductivity of the air electrode 120. Furthermore, an interface between the ion conductor and the electron conductor may be increased when a composite material of the ion-electron conductor 121 is used rather than when only the electron conductor is used, which may increase an effective reaction region in the air electrode 120. A La-based oxide, such as La_{0.8}Sr_{0.2}MnO₃, used as a material of a conventional air electrode 120 is close to an electron conductor having low ion conductivity, and when the La-based oxide is used, the reaction region may be limited to an interface between the air electrode 120 and the electrolyte 130 or the interface between the electron conductor and the ion conductor in the air electrode 120. In this example embodiment, the reactivity of the air electrode 120 may be enhanced using the ion-electron conductor 121 having a composition in which Sc is partially substituted at site B. On the other hand, the ion conductor 122 may include at least one of scandia stabilized zirconia (SSZ), yttria stabilized zirconia (YSZ), scandia ceria stabilized zirconia (SCSZ), scandia ceria yttria stabilized zirconia (SCYSZ), or scandia ceria ytterbia stabilized zirconia (SCYbSZ). By including the ion conductor 122, the ion conductivity may be further increased in the air electrode 120, and a reaction region may be increased. A weight ratio of the ion-electron conductor 121 to the ion conductor 122 in the air electrode 120 may range from 30:70 to 70:30. When the weight ratio of the ion-electron conductor 121 in the air electrode 120 is reduced to less than 30%, an electron conduction path may not be sufficiently secured. Furthermore, when the weight ratio of the ion conductor 122 is reduced to be less than 30%, a three-phase interface that may be provided as a reaction region in the air electrode 120 may not be sufficiently secured.

However, in the case of using the ion-electron conductor 121 in which site B is partially substituted by Sc as in this example embodiment, the air electrode 120 may have high ion conductivity, and in this case, the air electrode 120 may not include the ion conductor 122.

To explain a composition of the ion-electron conductor 121 in detail, the ion-electron conductor 121 basically has a perovskite structure represented by the equation of ABO₃, where A is a lanthanum-based oxide including La. In the present disclosure, A may further include at least one of Sr or Ca. That is, as at least one of Sr or Ca may be added to the composition of the ion-electron conductor 121, a portion of La may be substituted with at least one of Sr and Ca in the site A. In the present disclosure, a content of Sr or Ca, or a total content of Sr and Ca may be 40 mol (40 mol %) or less relative to the total content of 100 mol of A. In some embodiments, a content of Sr or Ca may be more than 0 mol (0 mol %) relative to the total content of 100 mol of A.

B includes Sc and at least one of Fe, Mn and Co. In other words, Sc is added to the composition of the ion-electron conductor r 121 in addition to polyhydric acid elements such as Fe, Mn, and Co, that is, doped with Sc, and some of the polyhydric acid elements are substituted with Sc. Sc has a fixed oxidation number (+3), and it is understood that oxygen vacancy may be induced by substituting some of the polyhydric acid elements such as Fe, Mn and Co, thereby increasing ion conductivity. In this case, a content of Sc may be set to a more appropriate range in consideration of characteristics such as electrical conductivity and ion conductivity. Specifically, the content of Sc in the ion-electron conductor 121 may be less than 10 mol (10 mol %), less than 9 mol (9 mol %), 8 mol (8 mol %), 7 mol (7 mol %), or 6 mol (6 mol %), relative to the total content of 100 mol of B, and more specifically, the content of Sc in the ion-electron conductor 121 may be 5 mol (5 mol %) or more, 6 mol (6 mol %) or more, 7 mol (7 mol %) or more, 8 mol (8 mol %) or more, 9 mol (9 mol %) or more, relative to the total content of 100 mol of B.

In some embodiments, the ion-electron conductor may include a compound represented by (La_{(1-a-b)}SrₐCa_{b}) (B′₍₁₋ₓ₎Srₓ)O₃, wherein B′ may be Fe, Mn and/or Co, 0≤a≤0.4, 0≤b≤0.4, and 0.05≤x≤0.1. The ion-electron conductor 121 may include LaFeO₃, LaSCO₃, LaMnO₃, LaCoO₃, SrFeO₃, SrSCO₃, SrMnO₃, SrCoO₃, CafeO₃, CAScO₃, CaMnO₃, or CaCoO₃.

The present inventors measured various characteristics by manufacturing the air electrode 121 using the composition having the above-described composition condition and compared the measured characteristics with comparative examples (not adding Sc). Furthermore, the characteristics were examined by dividing the condition into a case of using the ion-electron conductor 121 alone to which Sc was added and a case in which the ion conductor 122 in addition to Sc was used together.

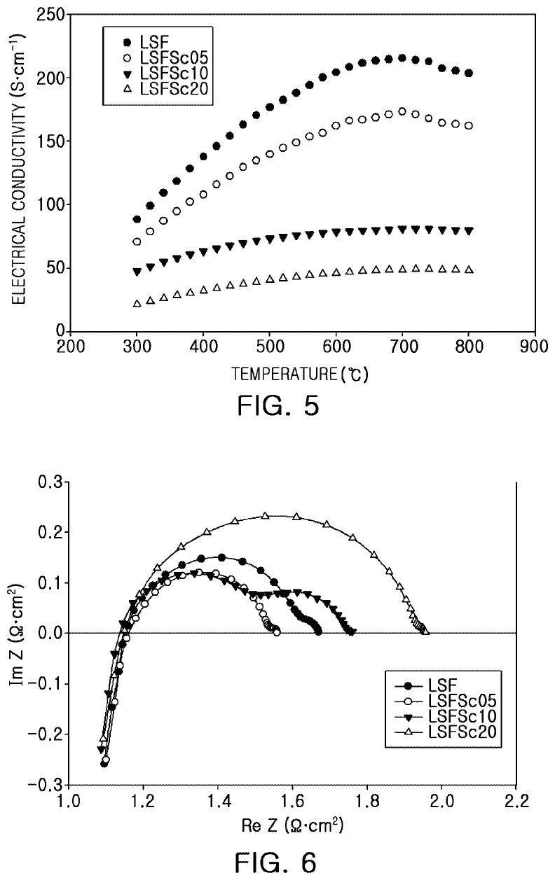

First, FIG. 5 is a graph illustrating a result of measuring a change in electrical conductivity according to a temperature in an air electrode obtained from compositions having different addition amounts of Sc. Here, LSF (Sc: 0 mol %) represents La_{0.6}Sr_{0.4}FeO₃, LSFSc05 (Sc: 5 mol %) represents La_{0.6}Sr_{0.4}Fe_{0.95}SC_{0.05}O₃, LSFSc10 (Sc: 10 mol %) represents La_{0.6}Sr_{0.4}Fe_{0.9}SC_{0.1}O₃, and LSFSc20 (Sc: 20 mol %) represents La_{0.6}Sr_{0.4}Fe_{0.8}SC_{0.2}O₃. Referring to experimental results of FIG. 5, when Sc is added to the LSF composition, the electrical conductivity is lower than that of the LSF composition, from which it may be seen that with an increase in an addition amount of Sc, the electrical conductivity decreases. Accordingly, it may be understood that when Sc having a fixed oxidation number is added to site B of the perovskite structure represented by ABO₃, a Zener Double-Exchange Mechanism may reduce the electrical conductivity. However, according to the research of the inventors, it may be found that even if the electrical conductivity is slightly reduced by an addition of Sc, there was no problem in functioning as the air electrode 120, and in comparison therewith, as described below, an effect of improving performance by increasing the ion conductivity was remarkable.

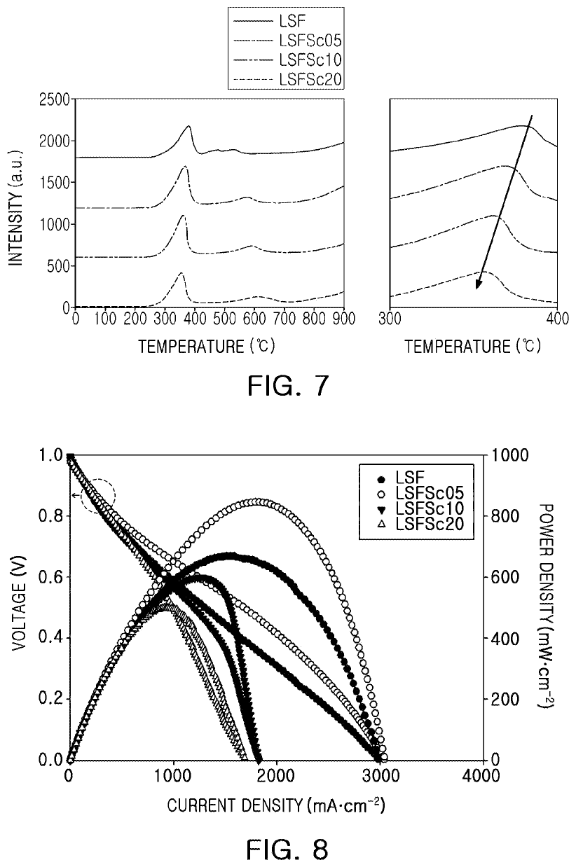

Next, FIG. 6 is a graph illustrating measurement of polarization resistance to an oxygen reduction reaction in an air electrode obtained from compositions having different addition amounts of Sc. In the graph of FIG. 6, a horizontal axis thereof represents a real portion of an impedance, and a vertical axis thereof represents an imaginary portion of the impedance, and half of a distance between two X-intercepts in each curve corresponds to the polarization resistance. Referring to the experimental results, it may be seen that when Sc is added, the polarization resistance tends to decrease as compared to an LSF composition except for LSFSc20 (Sc: 20 mol %). It may be understood that although Sc was added to decrease the electrical conductivity, the polarization resistance of the electrode may be rather decreased because a concentration of oxygen vacancy in a material increases to improve overall oxygen ion conductivity. Upon examining the results of an H₂-Temperature Programmed Reduction (TPR) analysis of FIG. 7, it may be confirmed that Fe³⁺ ions are formed at lower temperatures in relation to the amount of Sc, from which it may be predicted that the oxygen vacancy is more easily formed. Furthermore, when measuring the polarization resistance of the electrode according to an oxygen partial pressure, it can be inferred where a reaction determination step of the corresponding electrode is, and accordingly, it can be known that as a reaction rate determination value (i.e., an m value) is closer to 1, a gas diffusion step is the reaction rate determination step. Table 1 below shows the reaction rate determination value (i.e., the m value) according to the addition amount of Sc and temperatures, from which it may be seen that with an increase in the addition amount of Sc, the m value (calcination at 1050° C.) increases. Furthermore, the m value increased rapidly in a composite electrode mixed with 50 wt % of YSZ, a pure ion conductor, through which it can be confirmed that the effect of adding Sc is substantially the same as the effect of mixing the ion conductor.

TABLE 1

| | 800° C. | 700° C. | 600° C. |
|---|---|---|---|
| LSF | 0.1179 | 0.0825 | 0.1021 |
| LSFSc05 | 0.1656 | 0.1891 | 0.2291 |
| LSFSc10 | 0.3355 | 0.3299 | 0.3306 |
| LSFSc20 | 0.4307 | 0.3701 | 0.3958 |
| LSFSc20 + YSZ (50 wt %) | 0.6076 | 0.4888 | 0.4206 |

Next, FIG. 8 is a view illustrating a relationship between current density and voltage in a solid oxide cell including the air electrode obtained from the compositions having different addition amounts of Sc, and power density according thereto. As illustrated in a graph of FIG. 8, among a number of lines, substantially straight lines represent voltage (i.e., a left vertical axis), parabolic lines represent power density (i.e., a right vertical axis), where the power density corresponds to a product of current density and voltage. Referring to the experimental results, it may be seen that the air electrode including the ion-electron conductor having a composition in which Sc is added in an amount of 5 mol % has the highest output power density.

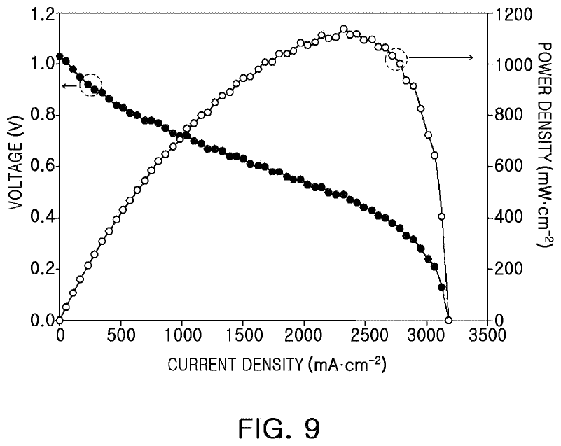

Next, FIG. 9 is a view illustrating a relationship between current density and voltage in an air electrode formed by mixing a composite obtained by mixing LSFSc05 (Sc: 5 mol %) and an ion conductor (YSZ), and power density according thereto. Here, a weight ratio of the ion-electron conductor to the ion conductor included in the composite is 1. As may be seen from the experimental results of FIG. 9, it may be found that the power is increased by 30% or more when the ion conductor is added in addition to the ion-electron conductor. Furthermore, as described in the experimental results of Table 1, when the ion conductor such as YSZ is added, a rapid reaction order improvement result similar to the addition of Sc may be obtained. The weight ratio of LSFSc05 to YSZ may not be limited in this example, and may be within the range of 30:70 to 70:30.

The present disclosure is not limited to the above-described example embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

What is claimed is:

1. A solid oxide cell comprising:
a fuel electrode;
an air electrode; and
an electrolyte disposed between the fuel electrode and the air electrode,
wherein the air electrode includes an ion-electron conductor and an ion conductor, and
the ion-electron conductor comprises a compound represented by ABO₃, where A includes La, and B includes Sr and at least one of Fe, Mn or Co.

2. The solid oxide cell according to claim 1, wherein A further includes at least one of Sr or Ca.

3. The solid oxide cell according to claim 2, wherein a content of the at least one of Sr or Ca is 40 mol or less relative to a total content of 100 mol of A.

4. The solid oxide cell according to claim 1, wherein a content of Sc is less than 10 mol relative to a total content of 100 mol of B.

5. The solid oxide cell according to claim 4, wherein the content of Sc is 5 mol or more relative to the total content of 100 mol of B.

6. The solid oxide cell according to claim 1, wherein the ion conductor includes at least one of scandia stabilized zirconia (SSZ), yttria stabilized zirconia (YSZ), scandia ceria stabilized zirconia (SCSZ), scandia ceria yttria stabilized zirconia (SCYSZ), and/or scandia ceria ytterbia stabilized zirconia (SCYbSZ).

7. The solid oxide cell according to claim 1, wherein a weight ratio of the ion-electron conductor to the ion conductor in the air electrode is 30:70 to 70:30.

8. A solid oxide cell comprising:
a fuel electrode;
an air electrode; and
an electrolyte disposed between the fuel electrode and the air electrode,
wherein the air electrode includes an ion-electron conductor,
the ion-electron conductor comprises a compound represented by ABO₃, where A includes La, B includes Sc and at least one of Fe, Mn or Co, and,
a content of Sc is less than 10 mol relative to a total content of 100 mol of B.

9. The solid oxide cell according to claim 8, wherein the content of Sc is 5 mol or more relative to the total content of 100 mol of B.

10. A composition for an air electrode of a solid oxide cell, wherein the composition comprises a compound represented by ABO₃, where A includes La, B includes Sc and at least one of Fe, Mn or Co, and
a content of Sc is less than 10 mol relative to the total content of 100 mol of B.

11. The composition for an air electrode of a solid oxide cell according to claim 10, wherein the content of Sc is 5 mol or more relative to the total content of 100 mol of B.

12. The composition for an air electrode of solid oxide cell according to claim 10, wherein A further includes Sr.

13. The composition for an air electrode of solid oxide cell according to claim 10, wherein a content of Sr is 40 mol or less relative to a total content of 100 mol of A.

14. The composition for an air electrode of solid oxide cell according to claim 10, wherein a content of Sc is less than 10 mol relative to a total content of 100 mol of B.

15. The composition for an air electrode of solid oxide cell according to claim 10, wherein B includes Sc and Fe.

16. The composition for an air electrode of solid oxide cell according to claim 10, wherein B includes Sc and Mn.

17. The composition for an air electrode of solid oxide cell according to claim 10, wherein B includes Sc and Co.

18. The solid oxide cell according to claim 1, wherein A further includes Sr, and the ion conductor includes yttria stabilized zirconia (YSZ).

19. The solid oxide cell according to claim 1, wherein B includes Sr and Fe.

20. The solid oxide cell according to claim 19, wherein a weight ratio of the compound represented by ABO₃ to the yttria stabilized zirconia (YSZ) in the air electrode is 30:70 to 70:30.
